(19) United States
(12) Patent Application Publication
(10) Pub. No.: US 2005/0205230 A1
(43) Pub. Date: Sep. 22, 2005

(54) Molded article and molding die

(76) Inventor: Hirokazu Kato, Ama-gun (JP)

Correspondence Address: POSZ LAW GROUP, PLC, 12040 SOUTH LAKES DRIVE, SUITE 101, RESTON, VA, 20191, US

(21) Appl. No.: 11/079,196

(22) Filed: Mar. 15, 2005

(30) Foreign Application Priority Data
Mar. 17, 2004 (JP) 2004-76513

(51) Int. Cl. B41D 3/00

(52) U.S. Cl. 164/139

(57) ABSTRACT

A molded article includes a pair of vertical walls formed with a pair of holes. Concave portions are formed in inner surfaces of the vertical walls between the holes and a bottom portion. The concave portions respectively extend from the inner surfaces toward outer surfaces of the vertical walls. A molding die has a base and a protrusion protruding from the base. The molding die is formed with concave portion forming portions protruding outward from two side surfaces of the protrusion opposite from each other. The concave portion forming portions are provided between hole forming portions and an end of the protrusion. The concave portion forming portions of the molding die form the concave portions of the molded article.

### CROSS REFERENCE TO RELATED APPLICATION

This application is based on and incorporates herein by reference Japanese Patent Application No. 2004-76513 filed on Mar. 17, 2004.

### BACKGROUND OF THE INVENTION

1. Field of the Invention

The present invention relates to a molded article having a pair of vertical walls formed with a pair of holes and to a molding die for forming the molded article.

2. Description of Related Art

Conventionally, a molded article such as a bearing has a pair of vertical walls formed with a pair of holes. Generally, the respective vertical walls are formed separately first, and then, the vertical walls are assembled and integrated. Thus, the molded article having the above structure is manufactured as disclosed in JP-A-H08-324321 (Patent Document 1), for instance. In this case, multiple molding dies for forming the respective vertical walls need to be prepared separately, and the assembling work is complicated. As a result, a manufacturing cost increases significantly.

If inner surfaces 112 of a pair of vertical walls 111 and a pair of holes 115 of a molded article 110 are formed by using a single molding die 100 and the vertical walls 111 are formed in a single piece when the molded article 110 having the pair of vertical walls 111 formed with the pair of holes 115 as shown in FIG. 10 is manufactured, the separate molding dies for forming the respective vertical walls 111 are unnecessary, and the assembling work is unnecessary. Therefore, in this case, the manufacturing cost can be reduced significantly.

The molding die 100 shown in FIG. 10 has a protrusion 102 and a pair of hole forming portions 105. The protrusion 102 extends from a base 101. The hole forming portions 105 extend outward from two side surfaces 103 of the protrusion 102 opposite from each other. The side surfaces 103 of the protrusion 102 form the inner surfaces 112 of the pair of vertical walls 111 of the molded article 110. The hole forming portions 105 form the pair of holes 115 of the molded article 110. The molding die 100 can form the inner surfaces 112 of the pair of vertical walls 111 and the pair of holes 115 of the molded article 110 at the same time. Therefore, the multiple types of molding dies are unnecessary and the assembling work for integrating the respective vertical walls is unnecessary.

The hole forming portions 105 of the molding die 100 are formed in undercut shapes. Therefore, the molding die 100 needs to be pulled out of the molded article 110 forcedly in a direction shown by an arrow mark “a” in FIG. 10. At that time, upside ends 116 of the hole forming portions 105 of the molding die 100 acutely push portions of the vertical walls 111 of the molded article 110 providing upper portions of outer edges of the holes 115 shown by dotted circles in FIG. 10 upward as shown by arrow marks F1. At that time, the vertical walls 111 pushed by the molding die 100 are urged to return to original shapes by elasticity thereof, since the vertical walls 111 are fixed to a bottom portion 120. Accordingly, the vertical walls 111 push the molding die 100 downward as shown by arrow marks F2 in FIG. 10. Thus, acute friction is caused between the upside ends 116 of the hole forming portions 105 of the molding die 100 and the portions of the vertical walls 111 of the molded article 110 providing the outer edge upper portions of the holes 115 due to the downward pushing forces F2 of the vertical walls 111 and the upward pushing forces F1 of the molding die 100. Thus, the portions of the vertical walls 111 providing the outer edge upper portions of the holes 115 are damaged or deformed. A manufacturing loss will be increased if the holes 115 are used as portions such as bearings requiring relatively high dimensional accuracy. As a result, the manufacturing cost cannot be reduced.

### SUMMARY OF THE INVENTION

It is therefore an object of the present invention to provide a molded article formed with holes, which have relatively high dimensional accuracy and are manufactured at a low cost, and a molding die of the molded article formed with such holes.

According to an aspect of the present invention, a molded article includes a bottom portion and a pair of vertical walls extending upward from an upper surface of the bottom portion. A distance is provided between the pair of vertical walls. The molded article is formed with a pair of holes at positions in inner surfaces of the respective vertical walls substantially facing each other. Each hole extends from the inner surface toward an outer surface of the vertical wall. A concave portion is formed on the inner surface of each vertical wall between the hole and the bottom portion. The concave portion extends from the inner surface toward the outer surface of the vertical wall.

According to another aspect of the present invention, a molding die for forming the above molded article includes a base, a protrusion, a pair of hole forming portions and concave portion forming portions. The protrusion protrudes from the base for forming the inner surfaces of the pair of vertical walls and the upper surface of the bottom portion of the molded article. The hole forming portions protrude outward from two side surfaces of the protrusion opposite from each other. The hole forming portions form the holes of the molded article. The concave portion forming portions protrude outward from positions on the side surfaces between the hole forming portions and a protrusion end of the protrusion. The concave portion forming portions form the concave portions of the molded article.

The concave portions are formed in the inner surfaces of the vertical walls of the molded article between the holes and the bottom portion. Each concave portion extends from the inner surface toward the outer surface of the vertical wall. The concave portion forming portions are formed between the hole forming portions and the protrusion end of the protrusion on the side surfaces of the protrusion opposite from each other. The concave portion forming portions extend outward from the side surfaces respectively. The concave portion forming portions of the molding die form the concave portions of the molded article.

When the molding die of the present invention is pulled out of the molded article of the present invention, the concave portion forming portions of the molding die upward push portions of the vertical walls providing outer edges of the concave portions of the molded article. Therefore, portions of the vertical walls on the end side from the concave portions with respect to the pulling direction, or portions of the vertical walls opposite from the bottom portion, are pushed upward by the concave portion forming portions. Likewise, portions of the vertical walls providing outer edges of the holes are pushed upward. Thus, friction between the upside ends of the hole forming portions and the portions of the vertical walls providing the outer edges of the holes is reduced. Accordingly, damage or deformation of the holes of the molded article can be inhibited when the molding die is pulled out of the molded article. As a result, the holes can be formed with high dimensional accuracy, and a manufacturing loss can be reduced. Thus, the molded article of the present invention can be manufactured at a low cost. The molding die of the present invention can manufacture the molded article formed with the holes having the high dimensional accuracy at a low cost.

### BRIEF DESCRIPTION OF THE DRAWINGS

Features and advantages of an embodiment will be appreciated, as well as methods of operation and the function of the related parts, from a study of the following detailed description, the appended claims, and the drawings, all of which form a part of this application. In the drawings:

FIG. 1 is a perspective view showing a molded article according to an embodiment of the present invention;

FIG. 2 is a perspective view showing a molding die according to the embodiment;

FIG. 3 is a schematic sectional view showing the molded article and the molding die according to the embodiment at a time before the molding die is pulled out of the molded article;

FIG. 4 is a schematic sectional view showing the molded article and the molding die according to the embodiment at a time when the molding die is pulled out of the molded article;

FIG. 5 is an enlarged schematic sectional view showing substantial portions of the molded article and the molding die according to the embodiment;

FIG. 6 is a schematic sectional view showing a molded article and a molding die of another example of the embodiment;

FIG. 7 is a schematic sectional view showing the molded article and the molding die of FIG. 6 at a time when the molding die is pulled out of the molded article;

FIG. 8 is a schematic sectional view showing a molded article and a molding die of yet another example of the embodiment;

FIG. 9 is a schematic sectional view showing the molded article and the molding die of FIG. 8 at a time when the molding die is pulled out of the molded article; and

FIG. 10 is a schematic sectional view showing a molded article and a molding die of a related art.

### DETAILED DESCRIPTION OF THE REFERRED EMBODIMENT

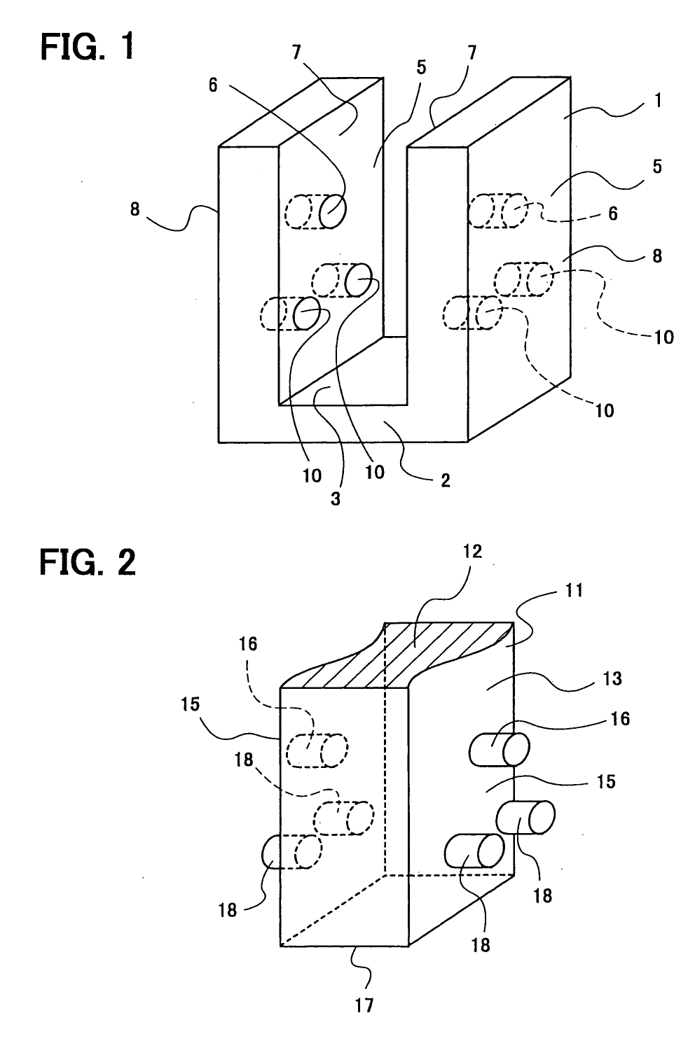

Referring to FIG. 1, a molded article 1 according to an embodiment of the present invention is illustrated.

The molded article 1 of the present embodiment is a bearing. The molded article 1 has a pair of vertical walls 5 formed with a pair of holes 6. The molded article 1 holds a pair of shaft portions press-fitted into the holes 6 at outer edges of the holes 6.

As shown in FIG. 1, the molded article 1 of the present embodiment includes a bottom portion 2 substantially in the shape of a flat plate, and the pair of vertical walls 5 extending upward in FIG. 1 from two ends of an upper surface 3 of the bottom portion 2 with respect to a longitudinal direction. The vertical walls 5 are disposed separately from each other. The vertical walls 5 are formed with the holes 6 at positions facing each other. Each hole 6 opens in an inner surface 7 of each vertical wall 5 and extends toward an outer surface 8 of the vertical wall 5. The holes 6 are formed substantially in the same shape.

Two concave portions 10 are formed on the inner surface 7 of each vertical wall 5 between the hole 6 and the bottom portion 2. Each concave portion 10 opens in the inner surface 7 and extends toward the outer surface 8. The concave portions 10 are formed substantially in the same shape.

A molding die 11 of the present embodiment for forming the molded article 1 of the present embodiment includes a base 12 and a protrusion 13 substantially in the shape of a rectangular column as shown in FIG. 2. The protrusion 13 protrudes from the base 12. A pair of hole forming portions 16 substantially in the shape of circular columns is formed near the base 12 respectively on two side surfaces 15 of the protrusion 13 opposite from each other. The hole forming portions 16 protrude outward from the two side surfaces 15 respectively. Concave portion forming portions 18 substantially in the shape of circular columns are formed on each side surface 15 between the hole forming portion 16 and a protrusion end 17 of the protrusion 13 so that the concave portion forming portions 18 protrude outward from each side surface 15. More specifically, two concave portion forming portions 18 are formed on each side surface 15. Thus, two pairs of concave portion forming portions 18 are formed on the pair of side surfaces 15.

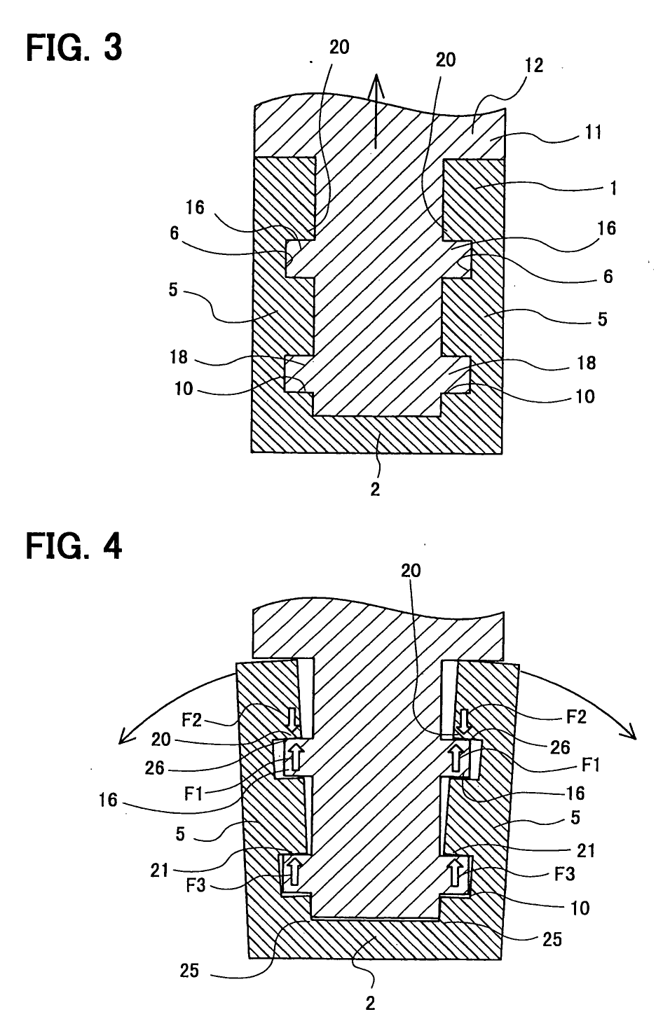

The hole forming portions 16 of the molding die 11 are in the respective holes 6 of the molded article 1 as shown in FIG. 3 before the molding die 11 is pulled out of the molded article 1. Therefore, when the molding die 11 is pulled out of the molded article 1, upward forces are applied to outer edge upper portions 20 of the holes 6 by the hole forming portions 16 as shown by arrow marks F1 in FIG. 4. The molded article 1 is urged to return to the original shape by elasticity thereof. Therefore, downward forces are applied to the outer edge upper portions 20 of the holes 6 by the elasticity as shown by arrow marks F2 in FIG. 4. Due to the upward forces F1 and the downward forces F2, friction is caused between the outer edge upper portions 20 of the holes 6 and the hole forming portions 16.

The molded article 1 is formed with the concave portions 10 between the holes 6 and the bottom portion 2. The concave portion forming portions 18 of the molding die 11 are in the respective concave portions 10 of the molded article 1 before the molding die 11 is pulled out of the molded article 1. Accordingly, when the molding die 11 is pulled out of the molded article 1, upward forces are applied to outer edge upper portions 21 of the concave portions 10 by the concave portion forming portions 18 as shown by arrow marks F3 in FIG. 4. Therefore, the forces F1 are cancelled or reduced by the forces F3. Thus, the friction between the hole forming portions 16 and the outer edge upper portions 20 of the holes 6 can be prevented or alleviated. As a result, the damage or the deformation of the outer edge upper portions 20 of the holes 6 can be prevented or alleviated when the molding die 11 is pulled out of the molded article 1.

At that time, the vertical walls 5 of the molded article 1 sway outward, respectively centered on connections 25 where the vertical walls 5 are connected to the bottom portion 2. Therefore, the outer edge upper portion 20 of each hole 6 moves along an arc, of which a center coincides with the connection 25. Thus, the outer edge upper portion 20 of the hole 6 approaches or contacts an upside end 26 of the hole forming portion 16. However, the upward forces F1 are cancelled or reduced by the upward forces F3 when the molding die 11 is pulled out of the molded article 1 of the present embodiment. Accordingly, acute friction between the upside ends 26 of the hole forming portions 16 and the outer edge upper portions 20 of the holes 6 can be prevented, and the shapes of the holes 6 can be maintained.

Therefore, the molded article 1 and the molding die 11 of the present embodiment can provide high dimensional accuracy of the holes 6. The pair of vertical walls 5 and the pair of holes 6 formed in the vertical walls 5 are formed in a single piece by the single molding die 11. Therefore, the molded article 1 can be manufactured at a low cost.

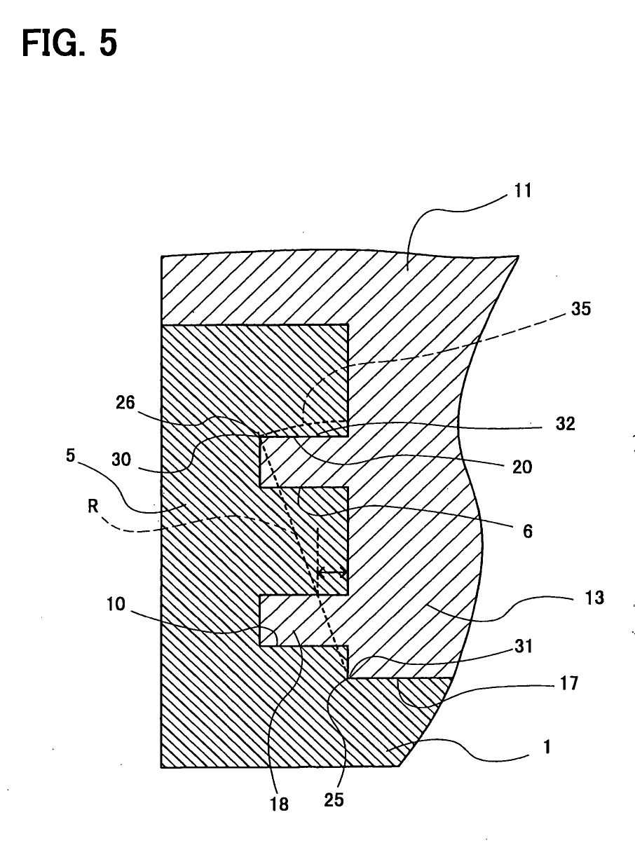

The concave portions 10 of the molded article 1 and the concave portion forming portions 18 of the molding die 11 may be formed in any shapes if the shapes can cancel or reduce the forces F1 caused by the elasticity of the molded article 1 when the molding die 11 is pulled out of the molded article 1. For instance, in the case where the molding material of the molded article 1 is relatively hard, each concave portion 10 should be preferably formed so that the concave portion 10 extends outward further than a line segment R connecting the connection 25 with an upside extension end 30 of the hole 6 as shown in FIG. 5. Each concave portion forming portion 18 of the molding die 11 should be preferably formed so that the concave portion forming portion 18 extends outward further than a line segment connecting an end 31 of the protrusion end 17 of the protrusion 13 on the concave portion 10 side with the upside end 26, or the line segment R. The vertical wall 5 sways outward centered on the connection 25 when the molding die 11 is pulled out of the molded article 1. Therefore, in the case where the concave portion 10 and the concave portion forming portion 18 extend outward further than the line segment R, the upward force F3 can be increased and surely exerted.

Moreover, in this case, an upside portion 32 of each hole forming portion 16 should be preferably formed above an arc 35 (shown by a broken line in FIG. 5), of which a center coincides with the end 31 of the protrusion end 17 on the concave portion 10 side and of which a radius coincides with the line segment R. The outer edge upper portion 20 of the hole 6 of the molded article 1 should be preferably formed above an arc, of which a center coincides with the connection 25 and of which a radius coincides with the line segment R. Thus, the contact between the outer edge upper portion 20 of the hole 6 and the upside end 26 of the hole forming portion 16 can be prevented. As a result, the prevention of the damage or the deformation of the outer edge upper portion 20 of the hole 6 can be ensured further.

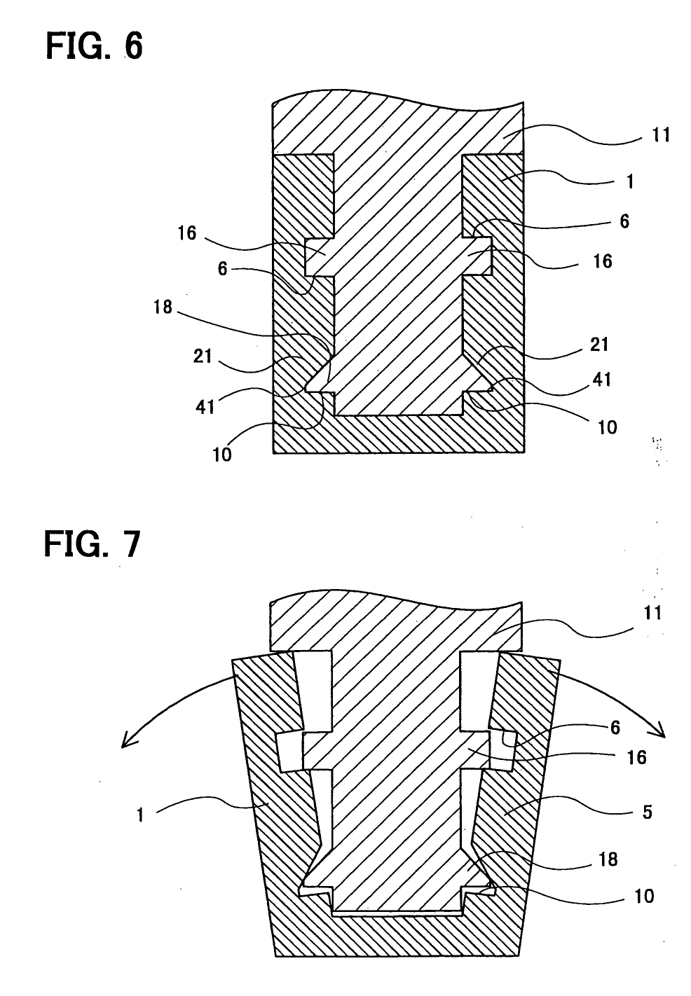

Alternatively, the upper surface of each concave portion forming portion 18 may be tapered so that the tapered surface declines outward as shown in FIG. 6. In this case, the concave portion forming portion 18 can be pulled out of the concave portion 10 more easily when the molding die 11 is pulled out of the molded article 1. Accordingly, the outer edge upper portion 21 of each concave portion 10 is pushed upward by the concave portion forming portion 18, and each vertical wall 5 easily sways largely outward as shown in FIG. 7. If the molding material of the molded article 1 is relatively soft, the concave portion forming portion 18 is pulled out of the concave portion 10 before the hole forming portion 16 is pulled out of the hole 6. Accordingly, a protrusion end 41 of the concave portion forming portion 18 pushes and sways the vertical wall 5 outward largely. Therefore, the friction between the outer edge upper portion 20 of the hole 6 and the hole forming portion 16 is alleviated further. As a result, the damage or the deformation of the outer edge upper portion 20 of the hole 6 can be prevented further.

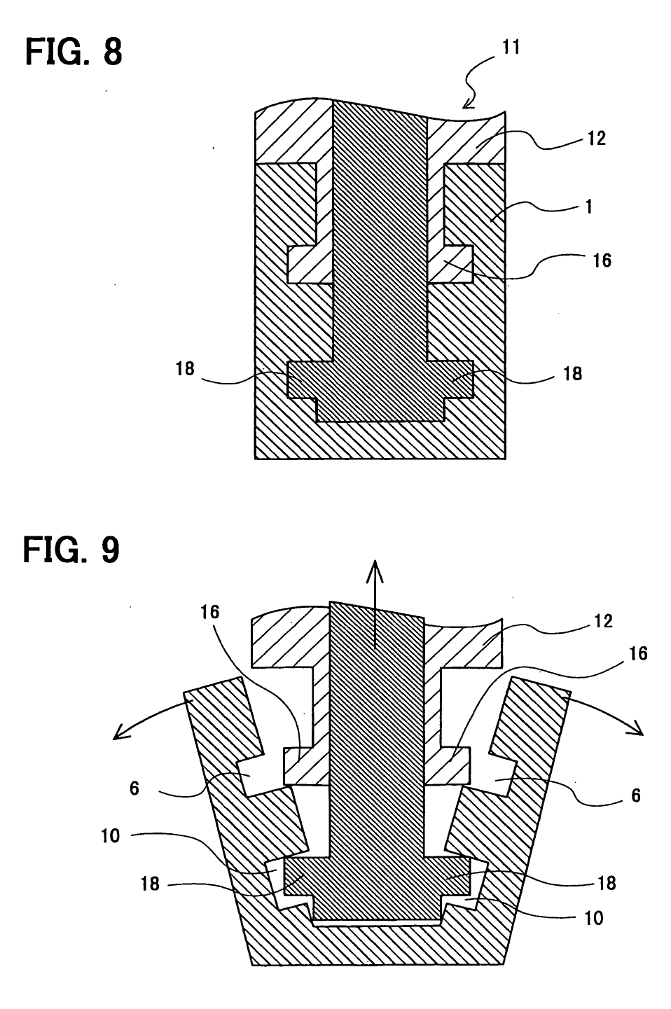

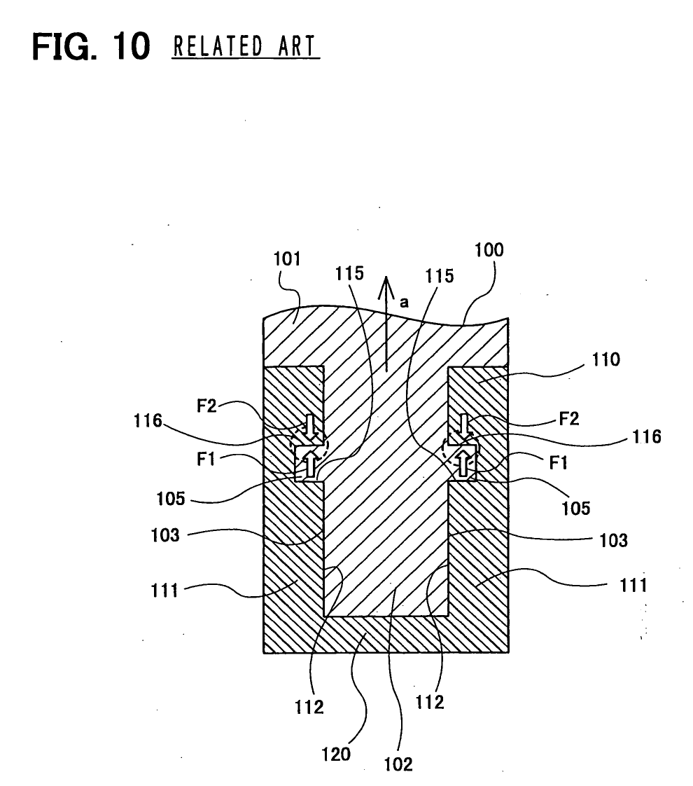

The concave portion forming portions 18 may be provided by a sliding core, which can slide toward the hole forming portions 16, or toward the base 12, as shown in FIGS. 8 and 9. In this case, when the molding die 11 is pulled out of the molded article 1, the sliding core including the concave portion forming portions 18 is slid toward the hole forming portions 16, first. Thus, the vertical walls 5 sway outward. At that time, the hole forming portions 16 can be pulled out of the holes 6 even if the hole forming portions 16 are not pulled upward. Therefore, the molding die 11 can be pulled out of the molded article 1 without applying the upward forces to the outer edge upper portions 20 of the holes 6. As a result, the friction between the outer edge upper portions 20 of the holes 6 and the hole forming portions 16 can be further alleviated, and the prevention of the damage or the deformation of the outer edge upper portions 20 of the holes 6 can be ensured further.

The present invention can also be applied to any other publicly known type of molded article if the molded article has a pair of vertical walls formed with a pair of holes.

The pair of vertical walls may be formed in parallel with each other or at a predetermined angle with each other. The shape of the protrusion of the molding die for forming the vertical walls is not limited to the shape of the present embodiment.

Only one pair of holes may be formed in the molded article. Alternatively, two or more pairs of holes may be formed in the molded article. Likewise, only one pair of concave portions may be formed in the molded article or two or more pairs of concave portions may be formed in the molded article. In the case where the multiple pairs of concave portions are formed, the friction between the upside ends of the hole forming portions and the portions of the vertical walls providing the outer edges of the holes can be alleviated more surely. The diameter of the concave portion should be preferably set to be larger than that of the hole in order to alleviate the friction more surely. Likewise, the diameter of the concave portion forming portion should be preferably set to be larger than that of the hole forming portion. Only one pair of hole forming portions may be provided or two or more pairs of hole forming portions may be provided. Likewise, only one pair of concave portion forming portions may be provided or two or more pairs of concave portion forming portions may be provided.

The directions of the holes or the concave portions formed in the vertical walls may be set to be parallel to the upper surface of the bottom portion. Alternatively, the directions of the holes or the concave portions formed in the vertical walls may be set at predetermined angles with respect to the upper surface of the bottom portion.

The present invention should not be limited to the disclosed embodiment, but may be implemented in many other ways without departing from the spirit of the invention.

1. A molded article comprising;
a bottom portion; and
a pair of vertical walls extending upward from an upper surface of the bottom portion so that a distance is provided between the vertical walls, wherein
the molded article is formed with a pair of holes at positions in inner surfaces of the respective vertical walls substantially facing each other so that the holes extend from the inner surfaces toward outer surfaces of the vertical walls, and
the vertical walls are formed with concave portions between the holes and the bottom portion so that the concave portions extend from the inner surfaces toward the outer surfaces.

2. A molding die for forming the molded article as in claim 1, the molding die comprising:
a base;
a protrusion protruding from the base for forming the inner surfaces of the vertical walls and the upper surface of the bottom portion of the molded article;
a pair of hole forming portions protruding outward from two side surfaces of the protrusion opposite from each other for forming the holes of the molded article; and
concave portion forming portions protruding outward from positions on the side surfaces between the hole forming portions and an end of the protrusion for forming the concave portions of the molded article.

3. The molding die as in claim 2, wherein
the concave portion forming portions are formed so that upper surfaces of the concave portion forming portions are tapered to decline outward.

4. The molding die as in claim 2, wherein
the concave portion forming portions are provided by a sliding core, which can slide toward the hole forming portions.
